(19) United States
(12) Patent Application Publication
(10) Pub. No.: US 2018/0270172 A1
(43) Pub. Date: Sep. 20, 2018

(54) INFORMATION PROCESSING DEVICE, INFORMATION PROCESSING METHOD, AND NON-TRANSITORY COMPUTER READABLE STORAGE MEDIUM

(71) Applicant: YAHOO JAPAN CORPORATION, Tokyo (JP)

(72) Inventors: Atsushi TOKUYAMA, Tokyo (JP); Kouhei YOKOTANI, Tokyo (JP)

(73) Assignee: YAHOO JAPAN CORPORATION, Tokyo (JP)

(21) Appl. No.: 15/913,054

(22) Filed: Mar. 6, 2018

(30) Foreign Application Priority Data
Mar. 17, 2017 (JP) 2017-053553

(51) Int. Cl. H04L 12/58; H04L 29/06

(52) U.S. Cl. CPC H04L 51/02; G06F 3/04817; H04L 65/403

(57) ABSTRACT

An information processing device according to the present application includes an interaction unit, a detection unit, and a change unit. The interaction unit performs interaction through dialogue with a user of a terminal device using the terminal device. The detection unit detects a transition of an aspect of the interaction. The change unit changes a mode of the interaction performed by the interaction unit when the detection unit detects the transition of the aspect.

### CROSS-REFERENCE TO RELATED APPLICATION

The present application claims priority to and incorporates by reference the entire contents of Japanese Patent Application No. 2017-053553 filed in Japan on Mar. 17, 2017.

### BACKGROUND OF THE INVENTION

### 1. Field of the Invention

The present invention relates to an information processing device, an information processing method, and a non-transitory computer readable storage medium.

### 2. Description of the Related Art

In recent years, an information processing device has been invented, which allows an interaction with a person by performing information processing using artificial intelligence related technology such as natural language processing and deep learning. For example, there is an information processing device that extracts, when receiving a query sentence in natural language, feature amounts contained in the input query sentence, and generates and outputs a response sentence to the query sentence using the extracted feature amounts (see Japanese Patent No. 5591871).

However, because the conventional information processing device capable of interacting with a person simply outputs a response sentence to the query sentence, there is room for improvement in terms of usefulness.

### SUMMARY OF THE INVENTION

It is an object of the present invention to at least partially solve the problems in the conventional technology.

An information processing device according to the present application includes an interaction unit, a detection unit, and a change unit. The interaction unit performs interaction through dialogue with a user of a terminal device using the terminal device. The detection unit detects a transition of an aspect of the interaction. The change unit changes a mode of the interaction performed by the interaction unit when the detection unit detects the transition of the aspect.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for explaining an example of a function effect exerted by an information processing device according to an embodiment;

FIG. 2 is a diagram for explaining an example of a functional configuration of the information processing device according to the embodiment;

FIG. 3 is a diagram illustrating an example of information to be registered in an interaction model database according to the embodiment;

FIG. 4 is a diagram illustrating an example of information to be registered in an aspect detection word database according to the embodiment;

FIG. 5 is a diagram illustrating an example of information to be registered in an advertising database according to the embodiment;

FIG. 6 is a flowchart for explaining an example of an information processing flow executed by the information processing device according to the embodiment;

FIG. 7 is an explanatory diagram illustrating another example of interaction performed by the information processing device according to the embodiment;

FIG. 8 is an explanatory diagram illustrating still another example of the interaction performed by the information processing device according to the embodiment;

FIG. 9 is an explanatory diagram illustrating still another example of the interaction performed by the information processing device according to the embodiment; and

FIG. 10 is a hardware configuration diagram illustrating an example of a computer implementing functions of the information processing device according to the embodiment.

### DETAILED DESCRIPTION OF THE PREFERRED EMBODIMENT

Some modes (hereinafter referred to as “embodiments”) for carrying out the information processing device, the information processing method, and the non-transitory computer readable storage medium according to the present application will be explained in detail below with reference to the accompanying drawings. It should be noted that the embodiments are not intended to limit the information processing device, the information processing method, and the non-transitory computer readable storage medium according to the present application. Moreover, in the following embodiments, the same reference signs are assigned to the same components and processes, and duplicate explanation is omitted.

The information processing device according to the embodiment (hereinafter simply referred to as “information processing device”) is a device that is connected to a terminal device via a communication network and performs interaction through dialogue with a user of a terminal device using the terminal device.

Hereinafter, a case where the information processing device provides Help service of a portal site by interaction to a user browsing the portal site (hereinafter simply referred to as “user”) using the terminal device will be explained as an example.

### 1. Concept of Information Processing

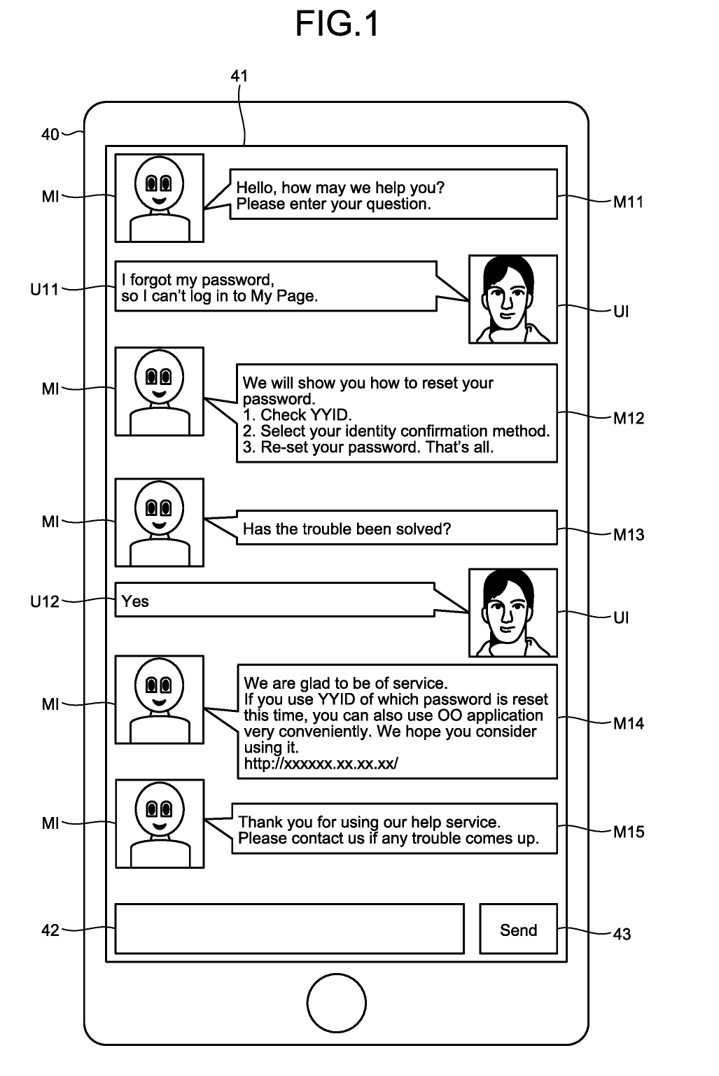

First of all, the concept of information processing executed by the information processing device will be explained with reference to FIG. 1. FIG. 1 is a diagram for explaining an example of a function effect exerted by the information processing device according to the embodiment.

The information processing device is a device that is implemented by a single or more information processing devices such as a server device and a cloud system and is communicable with a terminal device 40 used by the user via a network such as a mobile communication network or a wireless local area network (LAN).

As illustrated in FIG. 1, the terminal device 40 is, for example, a smartphone. The terminal device 40 may also be a tablet terminal, a personal digital assistant (PDA), a laptop personal computer (PC), and a desktop PC, each of which is communicable with the information processing device via the network.

For example, regarding portal site browsing, when a problem desired to be solved arises, the user of the terminal device 40 can use Help service by selecting a help icon in the portal site. When receiving a selection operation of the help icon by the user via a predetermined user interface (UI), the terminal device 40 establishes a connection with the information processing device.

On the other hand, when the connection with the terminal device 40 is established, then, the information processing device performs interaction for solving the user's problem through dialogue with the user using the terminal device 40.

For example, as illustrated in FIG. 1, the information processing device uses a display area 41 of the terminal device 40 to perform interaction in a chat format in which text information of a message is exchanged in real time with the user. In the following explanation, the text information of a message exchanged between the terminal device 40 and the information processing device may be described as message.

In the example illustrated in FIG. 1, when a message is output from the information processing device to the terminal device 40, a profile image MI of the information processing device appears on the left end in the display area 41. Then, the message output from the information processing device to the terminal device 40 is displayed on the right side of the profile image MI of the information processing device.

When a message is output from the terminal device 40 to the information processing device, a profile image UI of the user appears on the right end in the display area 41. Then, the message output from the terminal device 40 to the information processing device is displayed on the left side of the profile image UI of the user.

For example, when the connection with the terminal device 40 is established, the information processing device outputs a message M11 “Hello, how may we help you? Please enter your question.” to the terminal device 40.

The user enters a message in a character input box 42 provided in the lower side of the display area 41 and operates a send button 43 provided on the right side of the character input box 42, so that the message can be output to the information processing device.

Thus, the user can output, for example, a message U11 “I forgot my password, so I can't log in to My Page” from the terminal device 40 to the information processing device.

My Page mentioned here means a personized web page that the user customizes the portal site for himself/herself, and the user enters a predetermined ID and password to log in to the web page, which allows browsing thereof.

Thereafter, the information processing device performs interaction for solving the problem that the user desires to solve as a response to the message U11. For example, the information processing device outputs a message M12 “We will show you how to reset your password. 1. Check YYID. 2. Select your identity confirmation method. 3. Re-set your password. That's all.” to the terminal device 40.

Moreover, the information processing device outputs a message M13 “Has the trouble been solved?” to the terminal device 40. As a result, when it has been solved, the user can output, for example, the message U12 “Yes” from the terminal device 40 to the information processing device. In this way, the information processing device can provide the Help service for solving the user's problem through dialogue with the user using the terminal device 40.

However, the information processing device is not highly useful because only exchange of messages on one topic with the terminal device 40 in the above manner indicates mere exchange of very limited information. In other words, the information processing device cannot improve the usefulness only by performing interaction in a monotonous manner that a message as a response to the received message is output.

Therefore, the information processing device according to the embodiment detects a transition of an aspect of interaction (hereinafter sometimes simply referred to as “aspect”). At this time, the information processing device detects a transition of the aspect in the interaction in which there is no transition of topics among the dialogues with the user using the terminal device 40. When detecting the transition of the aspect, the information processing device changes the form of the interaction to improve the usefulness.

In the example as illustrated in FIG. 1, the information processing device detects a change in the aspect that occurs in a period during which the interaction on one topic such as “The user forgot his/her password, so he/she cannot log in to My Page” is carried out.

At this time, the user is in a psychologically negative state until the problem that the user cannot log in to My Page is solved since selection of the help icon in the portal site. Hereinafter, the aspect in which the user is in the psychologically negative state is referred to as “negative aspect”.

On the other hand, the user is in a psychologically positive state after the user's problem is solved by the Help service provided by the information processing device. Hereinafter, the aspect in which the user is in the psychologically positive state is referred to as “positive aspect”.

When the information processing device performs interaction with the terminal device 40 as explained above, the aspect of the interaction may sometimes change from the negative aspect to the positive aspect. And, the user is more likely to be tolerant of accepting new information at the positive aspect.

Therefore, when detecting the transition of the aspect, the information processing device performs interaction in a different form from the form in which the message as a response to the received message so far is output.

For example, as illustrated in FIG. 1, when receiving the message U12 “Yes” from the terminal device 40 as a reply to the message M13 “Has the trouble been solved?”, the information processing device detects the transition of the aspect.

The information processing device then outputs a message M14 “We are glad to be of service. If you use YYID of which password is reset this time, you can also use OO application very conveniently. We hope you consider using it.” to the terminal device 40. At this time, the information processing device outputs the message M14 including a uniform resource locator (URL) that can download the OO application to the terminal device 40.

Thereafter, the information processing device outputs a message M15 “Thank you for using our help service. Please contact us if any trouble comes up.” to the terminal device 40 and ends the Help service.

Thus, when detecting the transition of the aspect, the information processing device changes the form of the interaction so as to perform interaction in a form different from the form in which a message responding to the received message so far is output.

Specifically, when the problem that the user cannot log in to My Page is solved and the transition from the negative aspect to the positive aspect is detected, the information processing device outputs a message unrelated to the solution for the problem.

This makes it possible for the information processing device to offer, for example, some information on OO application that might be useful for the user in addition to the solution for the problem, thus improving the usefulness for the user.

The information processing device can also improve the usefulness for an administrator of the information processing device by bringing revenue, to the administrator thereof, obtained by advertising the OO application to the user who has requested the solution for the problem.

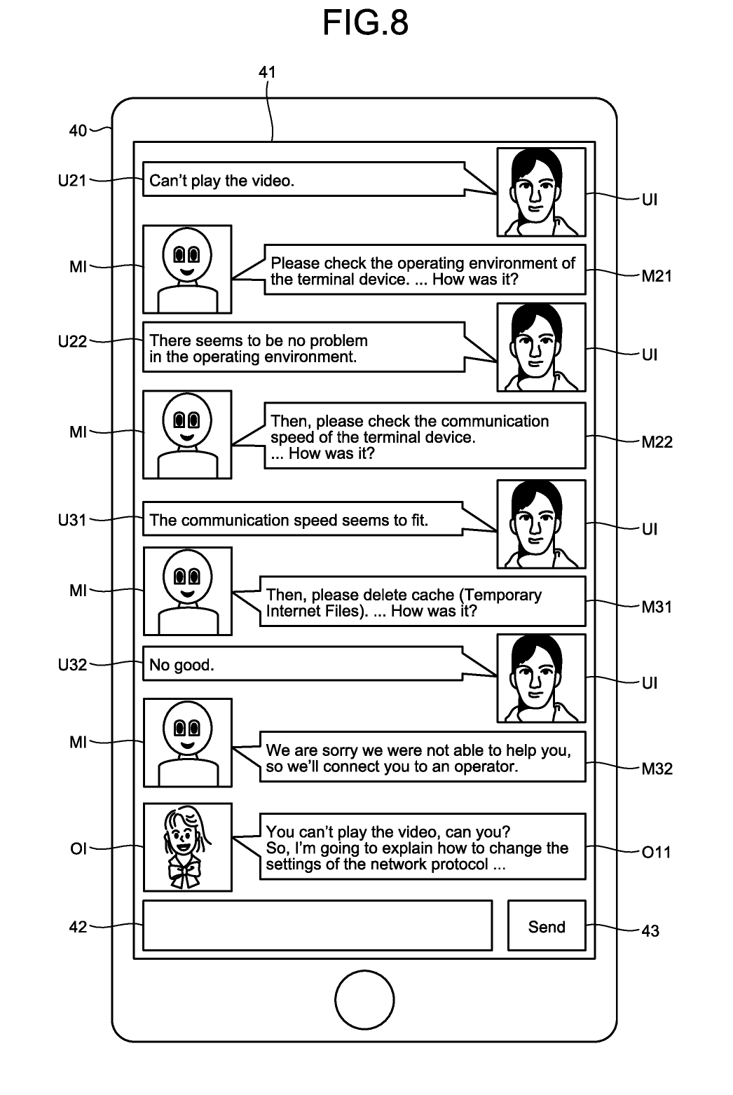

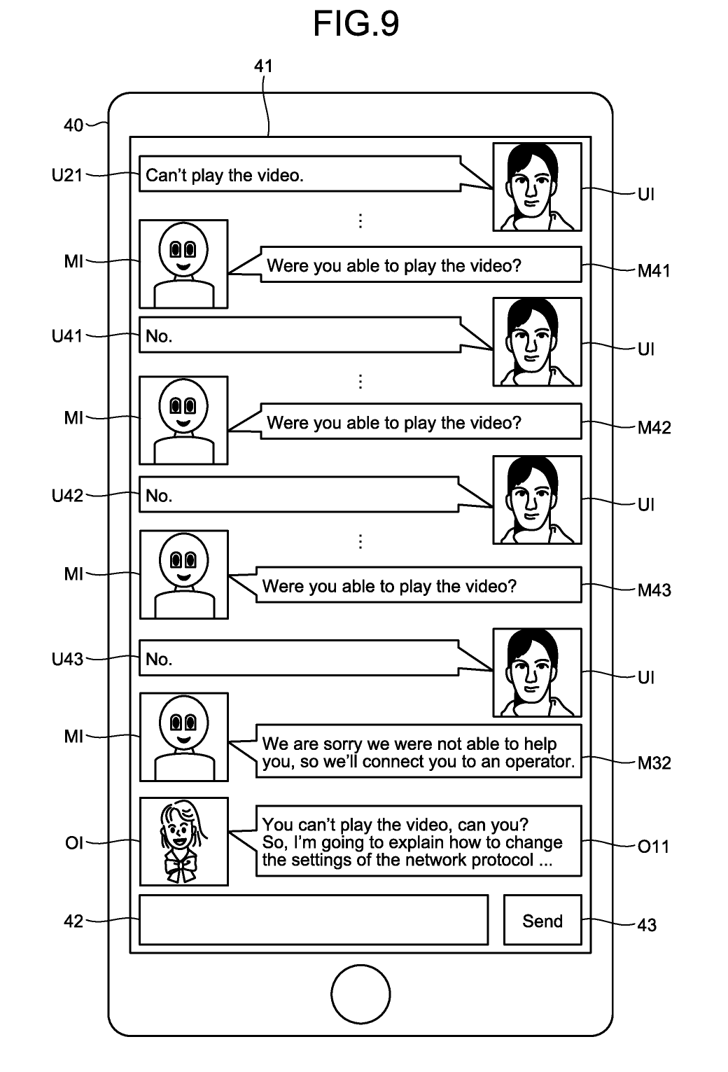

The aspect of the interaction may sometimes transition from a negative aspect to a more negative aspect. When detecting the transition of the aspect, the information processing device also changes the form of the interaction to a form different from the form until that time. The information processing will be explained later with reference to FIG. 8 and FIG. 9. An example of the functional configuration and function effect of the information processing device implementing the information processing will be explained below.

### 2. One Example of Functional Configuration of Information Processing Device

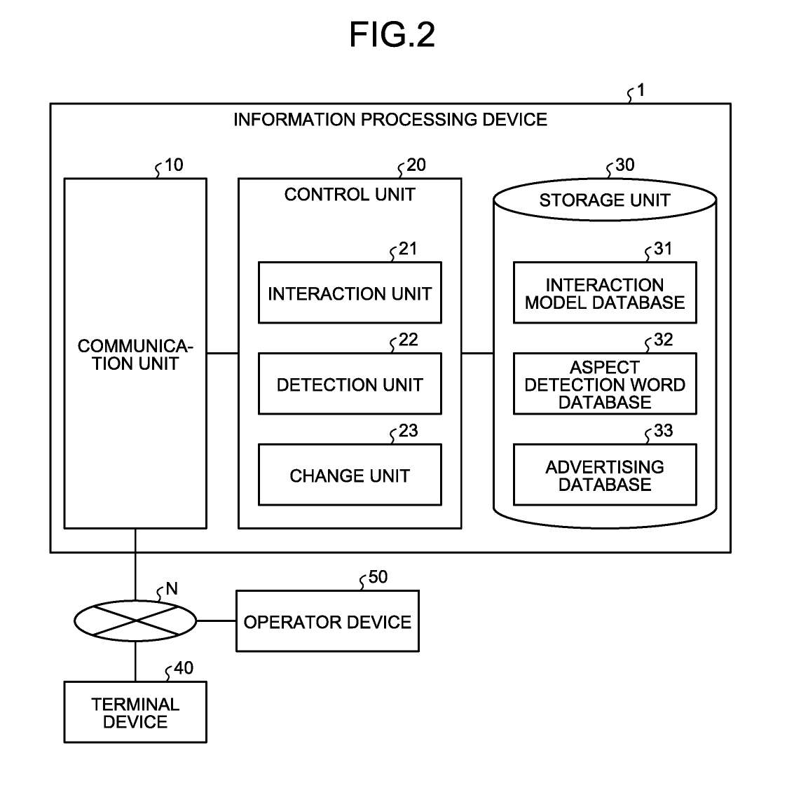

FIG. 2 is a diagram for explaining an example of a functional configuration of the information processing device according to the embodiment. As illustrated in FIG. 2, an information processing device 1 includes a communication unit 10, a control unit 20, and a storage unit 30. The communication unit 10 is implemented, for example, by a network interface card (NIC). The communication unit 10 is wired or wirelessly connected to a network N, and transmits and receives various pieces of information between the terminal device 40 and an operator device 50.

The operator device 50 is a device operated by an operator in charge of solving of a user's problem instead of the information processing device 1 when the information processing device 1 cannot solve the user's problem, and is implemented by, for example, a PC.

The storage unit 30 is implemented by a semiconductor memory device such as a random access memory (RAM) and a flash memory, or by a storage device such as a hard disk and an optical disk. The storage unit 30 includes an interaction model database 31 which is various types of data for executing information processing for which the information processing device 1 performs interaction, an aspect detection word database 32, and an advertising database 33.

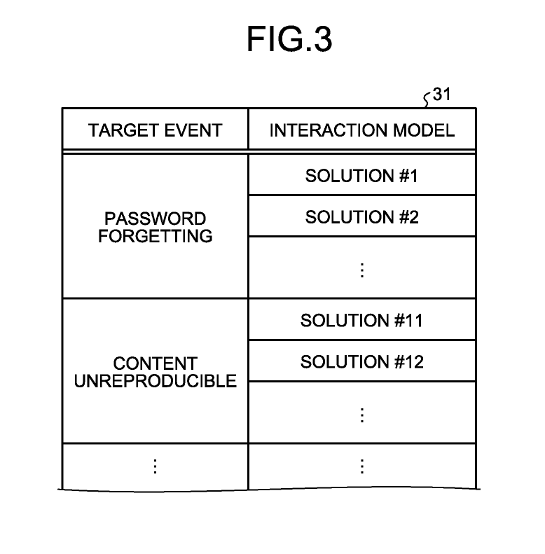

Here, each example of pieces of information to be registered in the interaction model database 31, the aspect detection word database 32, and the advertising database 33 will be explained with reference to FIG. 3 to FIG. 5.

For example, as illustrated in FIG. 3, a plurality of interaction models are registered in the interaction model database 31 in association with each target event of a plurality of problems expected that the user desires to solve.

For example, the interaction models such as Solution #1 and Solution #2 suggested by the information processing device 1 to the user who forgot the password are associated with the target event “Password Forgetting” and registered therein.

The Solution #1 is, for example, text information such as the messages M11 to M15 output from the information processing device 1 to the terminal device 40 by the interaction illustrated in FIG. 1. The Solution #2 is, for example, text information of messages on other solutions that the information processing device 1 outputs to the terminal device 40 when the target event “Password Forgetting” is not solved by the Solution #1.

Solution #11 is, for example, text information of messages on a solution that the information processing device 1 outputs to the terminal device 40 when a target event “Content Unreproducible” occurs in the terminal device 40. Solution #12 is, for example, text information of messages on other solutions that the information processing device 1 outputs to the terminal device 40 when the target event “Content Unreproducible” is not solved by the Solution #11.

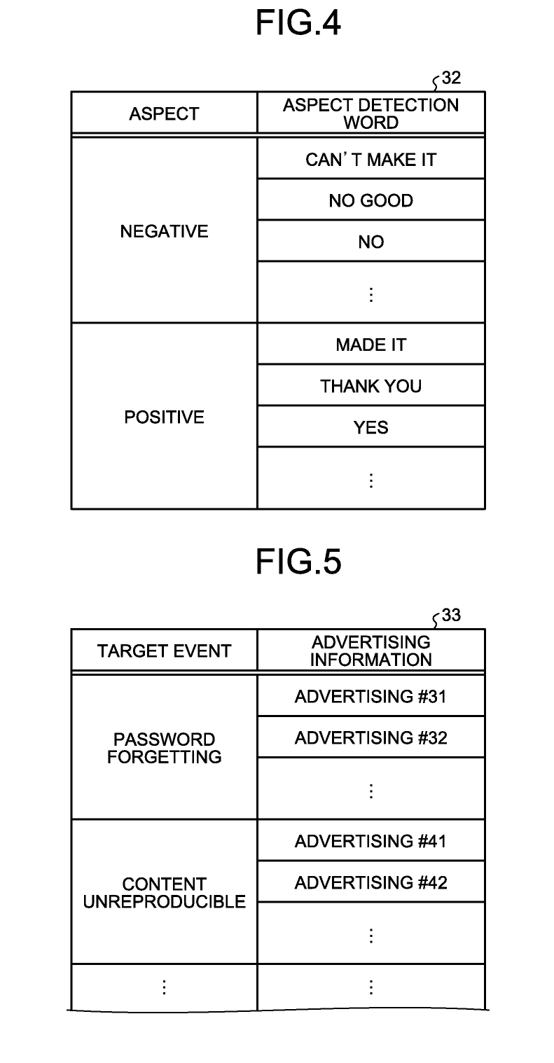

For example, as illustrated in FIG. 4, a plurality of aspect detection words are registered in the aspect detection word database 32 in association with respective different aspects of the interaction.

For example, aspect detection words, such as “Can't make it”, “No good”, and “No” which are more likely to be included in the messages received by the information processing device 1 from the terminal device 40 at the negative aspect, are associated with the negative aspect and registered therein. In other words, words that tend to be described in the messages the user outputs from the terminal device 40 to the information processing device 1 when the user is in a psychologically negative state are associated with the negative aspect and registered therein.

On the other hand, aspect detection words, such as “Made it”, “Thank you”, and “Yes” which are more likely to be included in the messages received by the information processing device 1 from the terminal device 40 at the positive aspect, are associated with the positive aspect and registered therein. In other words, words that tend to be described in the messages the user outputs from the terminal device 40 to the information processing device 1 when the user is in a psychologically positive state are associated with the positive aspect and registered therein.

For example, as illustrated in FIG. 5, a plurality of pieces of advertising information are registered in the advertising database 33 in association with each target event of a plurality of problems expected that the user desires to solve.

For example, Advertising #31 is advertising information (for example, the message M14 illustrated in FIG. 1) which the user may be interested in when the target event “Password Forgetting” can be solved by the Help service provided by the information processing device 1. Advertising #32 is advertising information other than Advertising #31 which the user may be interested in when the target event “Password Forgetting” can be solved.

Advertising #41 and Advertising #42 are different pieces of advertising information which the user may be interested in when the target event “Content Unreproducible” can be solved by the Help service provided by the information processing device 1.

Referring back to FIG. 2, the explanation of the control unit 20 will be continued. The control unit 20 is implemented, for example, by a central processing unit (CPU), a micro processing unit (MPU), an application specific integrated circuit (ASIC), or a field programmable gate array (FPGA) executing various programs stored in the storage device of the information processing device 1 using a storage area such as a RAM as a work area.

In the example illustrated in FIG. 2, the control unit 20 includes an interaction unit 21, a detection unit 22, and a change unit 23 (hereinafter sometimes collectively referred to as processing units 21 to 23).

A connection relation between the processing units 21 to 23 in the control unit 20 is not limited to the connection relation illustrated in FIG. 2 and may be any other connection relation. Although the processing units 21 to 23 implement and execute functions and actions (e.g., FIG. 1) of the information processing explained blow, these are functional units organized for explanation, and it does not matter whether they coincide with actual hardware elements and software modules. In other words, if the functions and the actions of the following information processing can be implemented and executed, the information processing device 1 may implement and execute guidance processing in arbitrary functional units.

### 3. One Example of Processing Executed by Information Processing Device

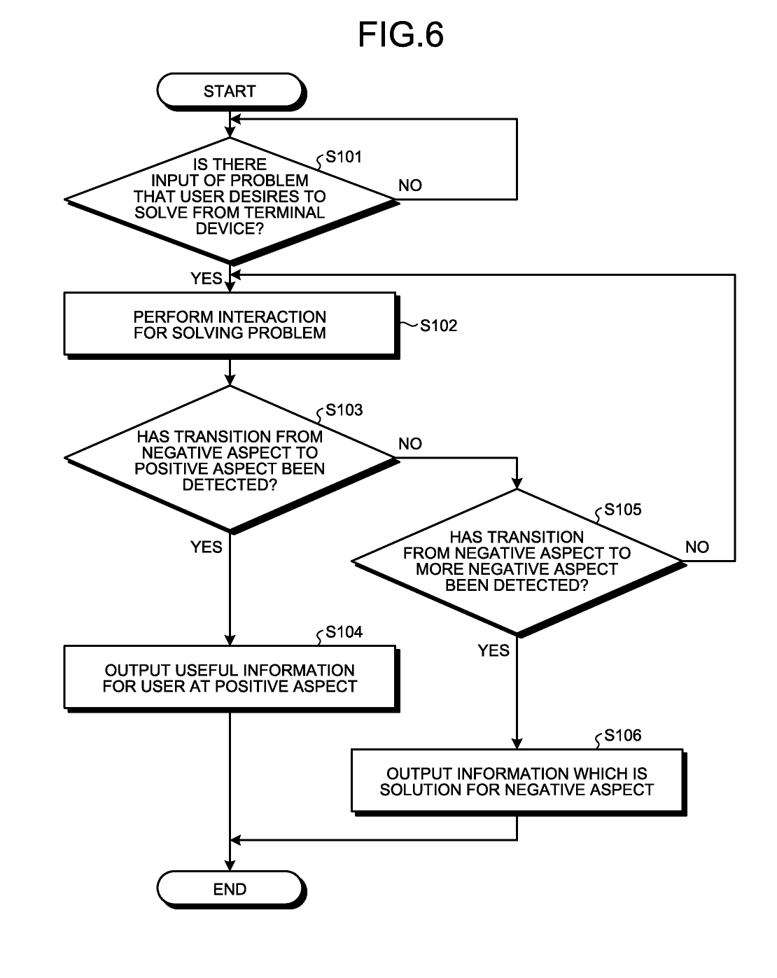

Content of the information processing executed and implemented by the processing units 21 to 23 will be explained below with reference to a flowchart illustrated in FIG. 6. FIG. 6 is a flowchart for explaining an example of an information processing flow executed by the information processing device 1 according to the embodiment.

Below is an explanation of an example of the processing executed by the processing units 21 to 23 of the information processing device 1 after the connection between the information processing device 1 and the terminal device 40 is established and an input request of a question is output from the information processing device 1 to the terminal device 40. The input request of the question herein is, for example, the message M11 illustrated in FIG. 1.

As illustrated in FIG. 6, first of all, the interaction unit 21 determines whether there is an input of a problem that the user desires to solve from the terminal device 40 (Step S101). When it is determined that there is no input of the problem from the terminal device 40 (No at Step S101), the interaction unit 21 repeats the determination processing at Step S101 until the problem is input.

When it is determined that there is an input of the problem from the terminal device 40 (Yes at Step S101), the interaction unit 21 recognizes that it is a negative aspect, and performs interaction for solving the problem.

When, for example, the message U11 illustrated in FIG. 1 is input from the terminal device 40, the interaction unit 21 analyzes the content of the message U11 and estimates the presence or absence of the problem that the user desires to solve and the content thereof.

The interaction unit 21 performs the information processing using, for example, the artificial intelligence related technology such as natural language processing and deep learning, and estimates that the user's problem is “Password Forgetting” from the message U11 illustrated in FIG. 1.

In this case, the interaction unit 21 acquires, for example, the Solution #1 associated with the “Password Forgetting” from the interaction model database 31 illustrated in FIG. 3. The interaction unit 21 then outputs the messages M12 and M13 illustrated in FIG. 1 using the Solution #1 and performs interaction for solving the problem.

Thereafter, the detection unit 22 determines whether a transition from the negative aspect to the positive aspect has been detected (Step S103). At this time, when receiving, for example, the message U12 illustrated in FIG. 1 from the terminal device 40, the detection unit 22 determines whether the aspect has transitioned based on the aspect detection word database 32 illustrated in FIG. 4.

For example, because the aspect detection word associated with the positive aspect “Yes” is included in the message U12 illustrated in FIG. 1, the detection unit 22 recognizes that the problem has been solved. That is, the detection unit 22 determines that the transition from the negative aspect to the positive aspect has been detected.

In this way, when the detection unit 22 determines that the transition from the negative aspect to the positive aspect has been detected (Yes at Step S103), the change unit 23 changes the form of the interaction performed by the interaction unit 21.

As a result, the interaction unit 21 performs the interaction in a form different from the form in which a message responding to the message received so far is output. Here, the interaction unit 21 outputs useful information for the user at the positive aspect to the terminal device 40 (Step S104).

In the example illustrated in FIG. 1, the interaction unit 21 acquires Advertising #31 associated with “Password Forgetting” from the advertising database 33 illustrated in FIG. 5, and outputs the message M14 illustrated in FIG. 1 to the terminal device 40. Thereafter, the interaction unit 21 outputs, for example, the message M15 illustrated in FIG. 1 to the terminal device 40, and ends the process.

Although the case where the user's problem is solved by outputting one suggestion from the information processing device 1 to the terminal device 40 is exemplified herein, the user's problem may not be solved by one suggestion. In such a case, the information processing device 1 can output another suggestion to the terminal device 40 in order to solve the user's problem.

Here, the example of transition from the negative aspect to the positive aspect when the user's problem is solved has been explained, however, there may be a transition from the negative aspect to the positive aspect even if the problem is not solved.

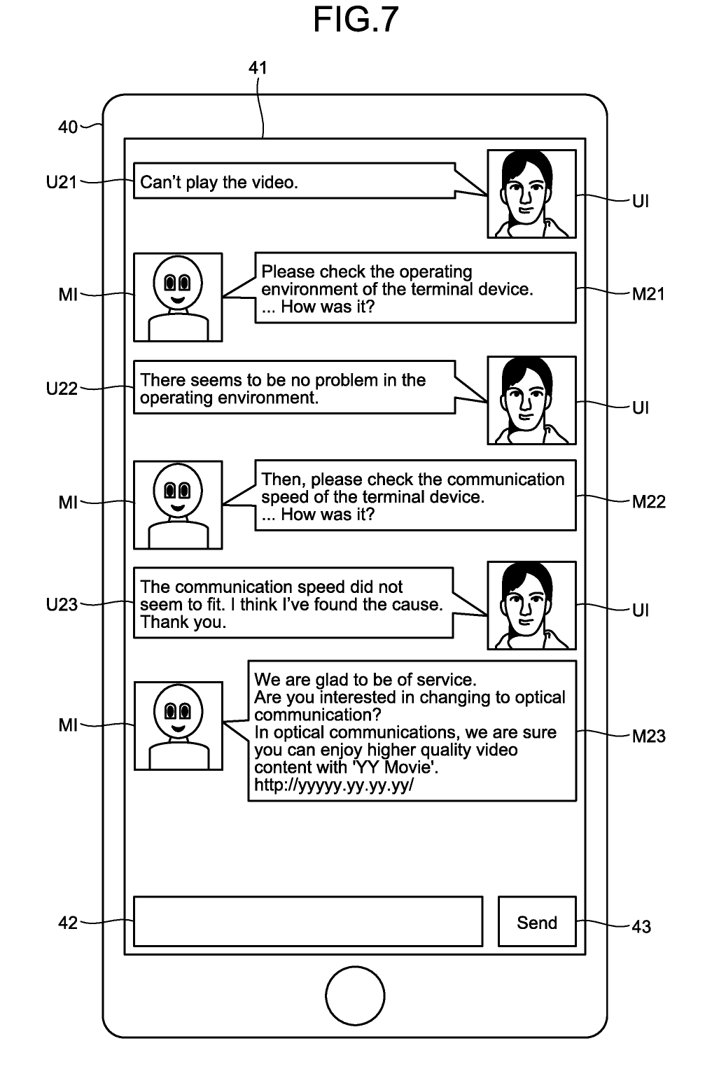

An example of the interaction in this case will be explained below with reference to FIG. 7. FIG. 7 is an explanatory diagram illustrating another example of the interaction performed by the information processing device 1 according to the embodiment.

For example, as illustrated in FIG. 7, the interaction unit 21 may receive a message U21 “Can't play the video” from the terminal device 40.

In this case, the interaction unit 21 determines that there is an input of the problem that the user desires to solve from the terminal device 40 (Yes at Step S101), and performs interaction for solving the problem (Step S102).

The interaction unit 21 outputs, for example, a message M21 “Please check the operating environment of the terminal device . . . . How was it?” illustrated in FIG. 7 to the terminal device 40.

Thereafter, the interaction unit 21 may receive, for example, a message U22 “There seems to be no problem in the operating environment” illustrated in FIG. 7 from the terminal device 40.

In this case, when the aspect detection word associated with the positive aspect is not included in the message U22, the detection unit 22 determines that the transition from the negative aspect to the positive aspect is not detected (No at Step S103).

At this time, there may be a case, for example, where the aspect detection word associated with the negative aspect is not included in the message U22. In this case, the detection unit 22 determines that the transition from the negative aspect to a more negative aspect is not detected (No at Step S105), and moves the process to Step S102.

The interaction unit 21 performs again the interaction for solving the problem (Step S102). The interaction unit 21 outputs, for example, a message M22 “Then, please check the communication speed of the terminal device . . . . How was it?” illustrated in FIG. 7 to the terminal device 40.

Thereafter, the interaction unit 21 may receive, for example, a message U23 “The communication speed did not seem to fit. I think I've found the cause. Thank you.” illustrated in FIG. 7 from the terminal device 40.

In this case, the aspect detection word “Thank you” associated with the positive aspect is included in the message U23. Therefore, the detection unit 22 determines that the transition from the negative aspect to the positive aspect has been detected.

In this way, when the detection unit 22 determines that the transition from the negative aspect to the positive aspect has been detected (Yes at Step S103), the change unit 23 changes the form of the interaction performed by the interaction unit 21.

As a result, the interaction unit 21 performs the interaction in a form different from the form in which a message responding to the message received so far is output. Here, the interaction unit 21 also outputs the useful information for the user at the positive aspect to the terminal device 40 (Step S104).

For example, the interaction unit 21 outputs a message M23 “We are glad to be of service. Are you interested in changing to optical communication? In optical communications, we are sure you can enjoy higher quality video content with ‘YY Movie’” illustrated in FIG. 7 to the terminal device 40. At this time, the interaction unit 21 outputs the message M23 including URL accessible to the web page of the YY Movie to the terminal device 40.

In this way, when the user's problem is not solved by the one suggestion, the information processing device 1 outputs a further suggestion to the terminal device 40 in order to solve the user's problem. As a result, when the negative aspect is transitioned to the positive aspect even when the user's problem is not solved, the information processing device 1 outputs the useful information for the user at the positive aspect to the terminal device 40. Thus the information processing device 1 can improve the usefulness.

There may be a case where the negative aspect transitions to a more negative aspect in the interaction. An example of the interaction when the transition is from the negative aspect to a more negative aspect will be explained below with reference to FIG. 8. FIG. 8 is an explanatory diagram illustrating still another example of the interaction performed by the information processing device 1 according to the embodiment.

Of the interaction illustrated in FIG. 8, the interaction from the message U21 at the beginning to the message M22 in which the information processing device 1 provides a second suggestion is the same as that of FIG. 7. Therefore, the interaction after the information processing device 1 provides the second suggestion will be explained below.

As illustrated in FIG. 8, after providing the second suggestion, the information processing device 1 may receive, for example, a message U31 “The communication speed seems to fit.” from the terminal device 40.

In this case, the interaction unit 21 continuously performs the interaction for solving the problem (Step S102). The interaction unit 21 outputs, for example, a message M31 “Then, please delete cache (Temporary Internet Files) . . . . How was it?” illustrated in FIG. 8 to the terminal device 40.

Thereafter, the interaction unit 21 may receive, for example, a message U32 “No good” illustrated in FIG. 8 from the terminal device 40. In this case, the detection unit 22 determines that the transition from the negative aspect to the positive aspect has not been detected because no aspect detection word associated with the positive aspect is included in the message U32 (No at Step S103).

Thereafter, the detection unit 22 determines whether the transition from the negative aspect to a more negative aspect has been detected (Step S105). Here, the aspect detection word “No good” associated with the negative aspect is included in the message U32.

Therefore, the detection unit 22 determines that the transition from the negative aspect to the more negative aspect has been detected (Yes at Step S105). In this way, when the detection unit 22 determines that the transition from the negative aspect to a more negative aspect has been detected (Yes at Step S105), the change unit 23 changes the form of the interaction performed by the interaction unit 21.

As a result, the interaction unit 21 performs the interaction in a form different from the form in which a message responding to the message received so far is sent back.

Here, the interaction unit 21 outputs the information which is a solution for the negative aspect to the terminal device 40 (Step S106), and ends the process. The interaction unit 21 outputs, for example, a message M32 “We are sorry we were not able to help you, so we'll connect you to an operator.” illustrated in FIG. 8 to the terminal device 40, and ends the process.

After the process at Step S106 is terminated, the information processing device 1 establishes the connection between the operator device 50 to be used by the operator and the terminal device 40. Thus, as illustrated in FIG. 8, a profile image OI of an operator appears in the display area 41 of the terminal device 40.

The operator device 50 outputs, for example, a message O11 “You can't play the video, can you? So, I'm going to explain how to change the settings of the network protocol . . . ” illustrated in FIG. 8 to the terminal device 40 according to the operation of the operator.

In this way, when the transition from the negative aspect to the more negative aspect is detected, the information processing device 1 outputs the information that is the solution for the negative aspect to the terminal device 40, thus further improving the usefulness.

The information processing device 1 according to the embodiment may be executed in various different forms other than the embodiment. Therefore, a modification of the embodiment will be explained next.

### 4. Modification

In the embodiment, when receiving the message including the aspect detection word associated with the negative aspect from the terminal device 40, the detection unit 22 has detected the transition from the negative aspect to a more negative aspect. However, the condition for detecting the transition from the negative aspect to a more negative aspect is not limited thereto.

For example, when receiving the message including an aspect detection word such as “No good” which is a comparatively strong expression among the aspect detection words associated with the negative aspect, the detection unit 22 may detect the transition to a more negative aspect.

In the case of such a configuration, even if receiving the message including an aspect detection word such as “No” which is a comparatively weak expression, the detection unit 22 does not intend to detect the transition to a more negative aspect.

As a result, when the detection unit 22 receives the message including the aspect detection word which is the comparatively weak expression, the change unit 23 can suppress frequent mode changes of the unnecessary interaction.

However, in the case of this configuration, the user may repeatedly outputs, for example, the message including the aspect detection word “No” which is the comparatively weak expression from the terminal device 40 to the interaction unit 21.

In this case, even if the aspect has actually transitioned from the negative aspect to a more seriously negative aspect, the detection unit 22 may overlook the transition of such an aspect.

Therefore, the detection unit 22 can also perform information processing for suppressing the oversight of the transition of such a serious aspect. Here, a modification of the condition that the detection unit 22 detects a transition from a negative aspect to a more negative aspect will be explained with reference to FIG. 9. FIG. 9 is an explanatory diagram illustrating still another example of the interaction performed by the information processing device 1 according to the embodiment.

As illustrated in FIG. 9, the interaction unit 21 may receive, for example, the message U21 “Can't play the video” from the terminal device 40. In this case, then, the messages exchanged between the interaction unit 21 and the terminal device 40 go back and forth, and the conversations may be in a loop.

For example, the interaction unit 21 outputs a solution to the terminal device 40, and then outputs a message M41 “Were you able to play the video?” illustrated in FIG. 9. Thereafter, the interaction unit 21 may receive a message U41 “No” illustrated in FIG. 9 from the terminal device 40.

In this case, the interaction unit 21 outputs another solution to the terminal device 40, and then outputs a message M42 “Were you able to play the video?” illustrated in FIG. 9. Thereafter, the interaction unit 21 may receive a message U42 “No” illustrated in FIG. 9 from the terminal device 40.

Thereafter, the interaction unit 21 outputs still another solution to the terminal device 40, and then outputs a message M43 “Were you able to play the video?” illustrated in FIG. 9. Thereafter, the interaction unit 21 may receive a message U43 “No” illustrated in FIG. 9 from the terminal device 40.

In this way, when the messages exchanged between the interaction unit 21 and the terminal device 40 go back and forth and the conversations are in a loop, the user is more likely to have a bad impression of the information processing device 1.

Therefore, when the number of times at which the conversations whose contents are similar to each other are exchanged between the terminal device 40 and the interaction unit 21 reaches a predetermined number, the detection unit 22 detects the transition from the negative aspect to a more negative aspect.

Then when the detection unit 22 determines that the transition from the negative aspect to a more negative aspect has been detected, the change unit 23 changes the form of the interaction performed by the interaction unit 21.

As a result, the interaction unit 21 performs the interaction in the form different from the form of the interaction so far in which the message responding to the received message is output.

For example, as illustrated in FIG. 9, the interaction unit 21 outputs the message M32 to the terminal device 40, similarly to the latter half of the interaction explained with reference to FIG. 8. The interaction unit 21 then hands over the response to the user to the operator, and causes the operator device 50 to output the message O11 illustrated in FIG. 9 to the terminal device 40.

Consequently, when it seems that the aspect detection word being a comparatively weak expression is continuously received and that not so seriously negative aspect continues, the detection unit 22 can suppress the oversight of the transition of the serious aspect which is actually occurring.

Moreover, for example, when the user's problem is not solved even when the number of times of conversations between the terminal device 40 and the interaction unit 21 has reached a predetermined times (e.g., three times), the detection unit 22 can also detect the transition to a more negative aspect.

Consequently, the detection unit 22 can also suppress the oversight of the transition of the serious aspect which is actually occurring when a negative aspect that is apparently not so serious seems to be continuing.

In the embodiment, although the detection unit 22 detects the transition of the aspect based on the aspect detection word included in the message received from the terminal device 40, this is only an example.

For example, the detection unit 22 may detect the transition of the aspect based on the operating state of the terminal device 40. Specifically, when the user's problem is the “Password Forgetting”, thereafter, the detection unit 22 acquires the information indicating the operating state of the terminal device 40 from the terminal device 40.

Then, when the information indicating that the terminal device 40 can log in to user's My Page is acquired from the terminal device 40, the detection unit 22 may determine the transition from the negative aspect to the positive aspect.

For example, when the user's problem is the “Content Unreproducible”, thereafter, the detection unit 22 acquires the information indicating the operating state of the terminal device 40 from the terminal device 40. When acquiring the information indicating that the terminal device 40 can reproduce the operation from the terminal device 40, the detection unit 22 may determine that the aspect has transitioned from the negative aspect to the positive aspect.

Thus, the detection unit 22 can quickly determine that the transition is from the negative aspect to the positive aspect before receiving a reply message from the terminal device 40. As a result, the interaction unit 21 can promptly output the useful information for the user at the positive aspect to the terminal device 40.

In the embodiment, although the case where the information processing device 1 provides Help service of the portal site by the interaction has been explained as an example, this is only an example. The information processing device 1 can be applied to a system that provides arbitrary service for performing interaction through dialogue with the user of the terminal device 40 using the terminal device 40.

In the embodiment, although the case where the information processing device 1 exchanges text messages with the terminal device 40 has been explained as an example, this is only an example. The information processing device 1 may be configured to exchange, for example, voice messages with the terminal device 40.

### 5. Other Embodiments

It should be noted that the embodiment is merely an example, and the present application includes those described herein below and other embodiments. For example, the functional configuration, the data structure, the sequence and content of the processes illustrated in the flowcharts in the present application are merely examples, and the presence or absence of each element, its arrangement, the sequence of process execution, the concrete content, and the like can be appropriately changed. For example, the information processing can also be realized as a device, a method, or a program in a cloud system in addition to these implemented by the information processing device 1 as exemplified in the embodiment.

It is also common to implement the processing units 21 to 23 that constitute the information processing device 1 by respective independent devices. Similarly, the configuration of the present application can be changed flexibly such as realizing each means illustrated in the embodiment by calling an external platform or the like with an application programming interface (API) or network computing (a so-called cloud, etc.). Moreover, each element such as means related to the present application may be implemented not only by an arithmetic control unit of a computer but also by other information processing mechanism such as a physical electronic circuit.

The information processing device 1 may be implemented by a front-end server for transmitting and receiving messages with the terminal device 40 and a back-end server for generating a message to be returned to the terminal device 40.

For example, when receiving a message from the terminal device 40, the front-end server outputs the received message to the back-end server. In this case, the back-end server outputs the message generated by executing information processing performed by the processing units 21 to 23 on the received message to the front-end server. The front-end server then outputs the message input from the back-end server, to the terminal device 40, as a response message to the message received by the terminal device 40.

### 6. Hardware Configuration

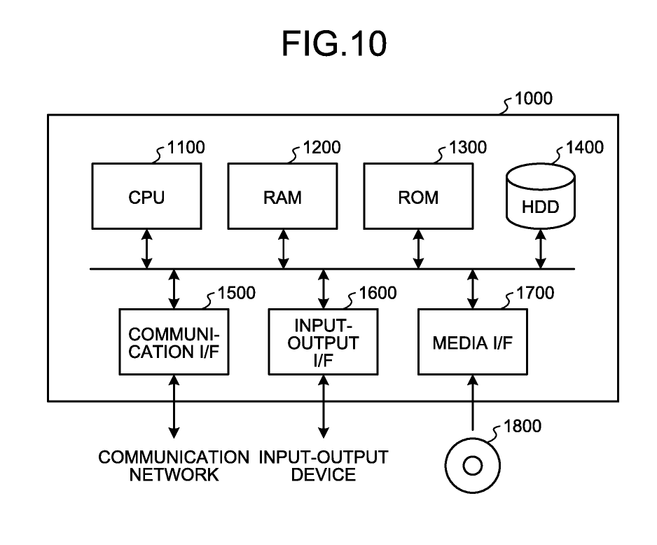

The information processing device 1 according to the embodiment is implemented by a computer 1000 having, for example, a configuration as illustrated in FIG. 10. FIG. 10 is a hardware configuration diagram illustrating an example of a computer implementing functions of the information processing device 1 according to the embodiment. The computer 1000 includes a central processing unit (CPU) 1100, a random access memory (RAM) 1200, a read-only memory (ROM) 1300, a hard disk drive (HDD) 1400, a communication interface (I/F) 1500, an input-output IF 1600, and a media I/F 1700.

The CPU 1100 operates based on the program stored in the ROM 1300 or in the HDD 1400, and controls each unit. The ROM 1300 stores a boot program executed by the CPU 1100 when the computer 1000 starts up, a program dependent on the hardware of the computer 1000, and the like.

The HDD 1400 stores a program executed by the CPU 1100, data used by the program, and the like. The communication I/F 1500 corresponds to the communication unit 10, receives data from other device via a communication network to be transmitted to the CPU 1100, and transmits the data generated by the CPU 1100 to other device via the communication network.

The CPU 1100 controls an output device such as a display and a printer and an input device such as a keyboard and a mouse via the input-output IF 1600. The CPU 1100 acquires data from the input device via the input-output IF 1600. In addition, the CPU 1100 outputs the generated data to the output device via the input-output IF 1600.

The media I/F 1700 reads the program or the data stored in a recording medium 1800, and provides the read program or data to the CPU 1100 via the RAM 1200. The CPU 1100 loads the program into the RAM 1200 from the recording medium 1800 via the media I/F 1700, and executes the loaded program. The recording medium 1800 is, for example, an optical recording medium such as a digital versatile disc (DVD) and a phase change rewritable disk (PD), a magneto-optical recording medium such as a magneto-optical disk (MO), a tape medium, a magnetic recording medium, or a semiconductor memory.

When the computer 1000 functions as the information processing device 1, the CPU 1100 of the computer 1000 executes an information providing program loaded into the RAM 1200. Thereby the computer 1000 implements the functions of the interaction unit 21, the detection unit 22, and the change unit 23. The HDD 1400 implements the function of the storage unit 30, and stores the interaction model database 31, the aspect detection word database 32, the advertising database 33, and the like.

The CPU 1100 of the computer 1000 reads these programs from the recording medium 1800 and executes them. However, as another example, the CPU 1100 may acquire these programs from other device via the communication network.

### 7. Advantageous Effects

As explained above, the information processing device 1 includes the interaction unit 21, the detection unit 22, and the change unit 23. The interaction unit 21 performs interaction through dialogue with the user of the terminal device 40 using the terminal device 40.

The detection unit 22 detects the transition of an aspect in the interaction. When the detection unit 22 detects the transition of the aspect, the change unit 23 changes the mode of the interaction performed by the interaction unit 21. Thereby the information processing device 1 can improve the usefulness more than that of an ordinary information processing device that continues the interaction in a simple form.

The detection unit 22 detects the transition of an aspect during the interaction in which there is no transition of topics in the dialogues. Thus, the information processing device 1 can improve the usefulness because various interactions are possible by changing the form of the interaction that tends to be monotonous with the same topic.

When the detection unit 22 detects the transition from the negative aspect to the positive aspect, the change unit 23 changes the mode of the interaction so as to output the useful information for the user at the positive aspect to the terminal device 40.

Thus, the information processing device 1 can improve the usefulness by offering useful information to the user who is more likely to be tolerant of accepting new information at the positive aspect.

The change unit 23 change the mode of the interaction so as to output advertising information as the useful information to the terminal device 40. Thus, the information processing device 1 can improve the usefulness for an administrator of the information processing device 1 by providing revenue, to the administrator of the information processing device 1, obtained by offering the advertising information to the user.

When the detection unit 22 detects the transition from the negative aspect to a more negative aspect, the change unit 23 changes the mode of the interaction so as to output the information which is a solution for the negative aspect to the terminal device 40.

Thus, when the aspect of the interaction transitions from the negative aspect to a more negative aspect, the information processing device 1 can improve the usefulness by offering useful information for the user to the user.

The change unit 23 changes the mode of the interaction so as to output information, as the information which is a solution for the negative aspect, indicating that the other party in the dialogue with the user is changed from the interaction unit 21 to the operator to the terminal device 40.

Thus, for example, when the negative aspect cannot be changed, by changing the other party in the dialogue with the user to the operator, the information processing device 1 can improve the usefulness for the user.

The interaction unit 21 receives an input of the problem the user desires to solve from the terminal device 40 and performs interaction for solving the problem. Then, when the problem has been solved, the detection unit 22 detects transition from the negative aspect to the positive aspect. Thereby the information processing device 1 can improve the usefulness for the user having the problem.

When the problem is not solved even if the number of times of dialogues between the terminal device 40 and the interaction unit 21 reaches the predetermined number, the detection unit 22 detects the transition from the negative aspect to a more negative aspect.

Thereby, when the negative aspect that is apparently not so serious seems to be continuing, the information processing device 1 can suppress the oversight of the transition of the serious aspect which is actually occurring.

Moreover, when the number of times at which conversations whose contents are similar to each other are exchanged between the terminal device 40 and the interaction unit 21 reaches the predetermined number, the detection unit 22 detects the transition from the negative aspect to a more negative aspect.

Thereby, when the negative aspect that is apparently not so serious seems to be continuing, the information processing device 1 can also suppress the oversight of the transition of the serious aspect which is actually occurring.

The detection unit 22 detects the transition of the aspect based on the contents of the conversations between the terminal device 40 and the interaction unit 21. This makes it possible for the information processing device 1 to more accurately determine the transition of the aspect.

Furthermore, the detection unit 22 detects the transition of the aspect based on the operating state of the terminal device 40. This makes it possible for the information processing device to quickly determine the transition of the aspect before the reply message is received from the terminal device 40.

Although some of the embodiments of the present application have been explained in detail with reference to the drawings, these are examples. It is therefore possible to implement the present application in other embodiments subjected to various modifications and improvements based on the knowledge of those skilled in the art including the modes described in the disclosure section of the application.

The above-mentioned “section, module, and unit” can be read as “means” or “circuit”. For example, the change unit can be read as a change means or a change circuit.

According to one aspect of the embodiments, it is possible to provide the information processing device, the information processing method, and the non-transitory computer readable storage medium capable of improving the usefulness.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device comprising:
an interaction unit configured to perform interaction through dialogue with a user of a terminal device using the terminal device;
a detection unit configured to detect a transition of an aspect of the interaction; and
a change unit configured to change a mode of the interaction performed by the interaction unit when the detection unit detects the transition of the aspect.

2. The information processing device according to claim 1, wherein
the detection unit is configured to detect the transition of the aspect in the interaction in which there is no topic transition of the dialogue.

3. The information processing device according to claim 1, wherein, when the detection unit detects the transition from a negative aspect to a positive aspect,
the change unit is configured to change the mode of the interaction so as to output useful information for the user at the positive aspect to the terminal device.

4. The information processing device according to claim 3, wherein
the change unit is configured to change the mode of the interaction so as to output advertising information as the useful information to the terminal device.

5. The information processing device according to claim 1, wherein, when the detection unit detects the transition from a negative aspect to a more negative aspect,
the change unit is configured to change the mode of the interaction so as to output information being a solution for the negative aspect to the terminal device.

6. The information processing device according to claim 5, wherein
the change unit is configured to change the mode of the interaction so as to output information, as the information being the solution for the negative aspect, indicating that the other party in the dialogue with the user is changed from the interaction unit to an operator.

7. The information processing device according to claim 1, wherein
the interaction unit is configured to receive an input of a problem that the user desires to solve from the terminal device and to perform the interaction for solving the problem, and
the detection unit is configured to detect, when the problem is solved, the transition from a negative aspect to a positive aspect.

8. The information processing device according to claim 7, wherein, when the problem is not solved even if the number of times of conversations between the terminal device and the interaction unit reaches a predetermined number,
the detection unit is configured to detect the transition from the negative aspect to a more negative aspect.

9. The information processing device according to claim 7, wherein, when the number of times at which conversations whose contents are similar to each other are exchanged between the terminal device and the interaction unit reaches a predetermined number,
the detection unit is configured to detect the transition from the negative aspect to a more negative aspect.

10. The information processing device according to claim 1, wherein
the detection unit is configured to detect the transition of the aspect based on the contents of conversations between the terminal device and the interaction unit.

11. The information processing device according to claim 1, wherein
the detection unit is configured to detect the transition of the aspect based on an operating state of the terminal device.

12. An information processing method executed by a computer, comprising:
performing interaction through dialogue with a user of a terminal device using the terminal device;
detecting a transition of an aspect of the interaction; and
changing a mode of the interaction performed at the performing interaction when the transition of the aspect is detected at the detecting.

13. A non-transitory computer readable storage medium having stored therein an information processing program, the program causing a computer to execute a process comprising:
performing interaction through dialogue with a user of a terminal device using the terminal device;
detecting a transition of an aspect of the interaction; and
changing a mode of the interaction performed at the performing interaction when the transition of the aspect is detected at the detecting.
